(19) United States
(12) Patent Application Publication
(10) Pub. No.: US 2015/0184422 A1
(43) Pub. Date: Jul. 2, 2015

(54) LOCK CORE STRUCTURE

(71) Applicant: YUN-HSIANG CHANG, PINGTUNG HSIEN (TW)

(72) Inventor: WEN-KUEI CHANG, PINGTUNG HSIEN (TW)

(73) Assignee: YUN-HSIANG CHANG, PINGTUNG HSIEN (TW)

(21) Appl. No.: 14/140,859

(22) Filed: Dec. 26, 2013

(51) Int. Cl. E05B 27/00

(52) U.S. Cl. CPC E05B 27/0003

(57) ABSTRACT

A lock core structure is revealed herein. It comprises a lock core and a plurality of locking pieces. The lock core has a keyhole for inserting and rotating a key therein and has a plurality of engaging holes arranged at least one row thereon for accommodating the locking pieces, wherein each of the engaging holes communicating with the keyhole is defined by a curved portion and a flat portion including at least one first flat surface, and each of the locking pieces for insertion into the to engaging holes has an E-shaped configuration and includes at least one second flat surface on laterals thereof to prop against the at least one first flat surface of the flat portion of the engaging hole.

### BACKGROUND OF THE INVENTION

1. Field of the Invention

The present invention relates to a lock core structure for avoiding casual movement of locking pieces inside an engaging hole so that a key can be smoothly inserted into a keyhole.

2. Description of Related Art

Generally, a traditional lock core structure mainly comprises a keyhole for inserting and rotating a key therein and plural engaging holes arranged at least one row thereon, wherein the engaging hole, each communicating with the keyhole and having a locking strip on the outer edge corresponding to a locking piece, can accommodate the locking piece. In the absence of a key in the keyhole of the lock core, the locking piece protrudes from a slot and latches on outer case of the lock core so that the lock core is in a closed state. On the other hand, in the presence of a key in the keyhole, teeth on the key corresponding to the locking pieces inside the engaging hole can drive locking pieces to move so that locking pieces are pressed into the slot. In such a case, rotating the key can also actuate the rotation of the lock core for unlocking.

Referring to FIG. 5, a schematic diagram showing a traditional lock core structure is revealed herein. A lock core (4) is disposed with a plurality of engaging holes (41) axially aligned at least one row. Each engaging hole (41) has a curved shape and is equipped with the same shape locking piece (42).

In the foregoing lock core structure, a key can drive locking pieces to control the movement of locking strips, but engaging holes and locking pieces all having the same shape is prone to cause casual movement of locking pieces inside the engaging holes. In such a case, the key cannot be successfully inserted into the keyhole of the lock core due to un-match of teeth on the key to the locking pieces within each engaging hole. Therefore, the traditional lock core structure still needs to be improved.

### SUMMARY OF THE INVENTION

In view of the above-mentioned problems, the object of the present invention is to provide a lock core structure comprising at least one first flat surface and at least one second flat surface for limiting each other in position. The lock core structure can prevent the locking pieces from casual movement and shift in the engaging holes and allow a key to be smoothly inserted into a keyhole of a lock core so as further to increase the expediency in use thereof.

Disclosed herein is a lock core structure including a lock core and a plurality of locking pieces. The lock core has a keyhole for insertion and rotation of a key therein and a plurality of engaging holes arranged at least one row thereon for accommodating the locking pieces. Each of the engaging holes communicating with the keyhole is defined by a curved portion and a flat portion, wherein the flat portion includes at least one first flat surface. Each of the locking pieces for insertion into the engaging hole has an E-shaped configuration and includes at least one second flat surface on laterals thereof to prop against the at least one first flat surface of the flat portion of each of the engaging holes.

According to an embodiment of the present invention, the engaging hole and the locking piece form a rectangular shape.

### BRIEF DESCRIPTION OF THE DRAWINGS

FIG. 1 is a perspective exploded view according to the present invention;

FIG. 2 is a schematic diagram showing the assembly of a lock core structure according to the present invention;

FIG. 3 is another perspective exploded view according to the present invention;

FIG. 4 is another schematic diagram showing a lock core structure in assembly;

FIG. 5 is a schematic diagram showing a traditional lock core structure.

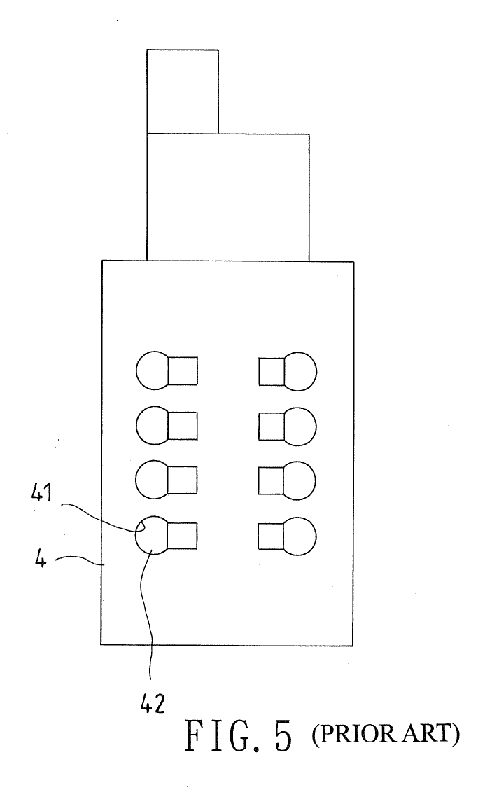

### DETAILED DESCRIPTION OF THE PREFERRED EMBODIMENT

Hereinafter, an exemplary embodiment of the present invention will be described in detail with reference to the accompanying drawings.

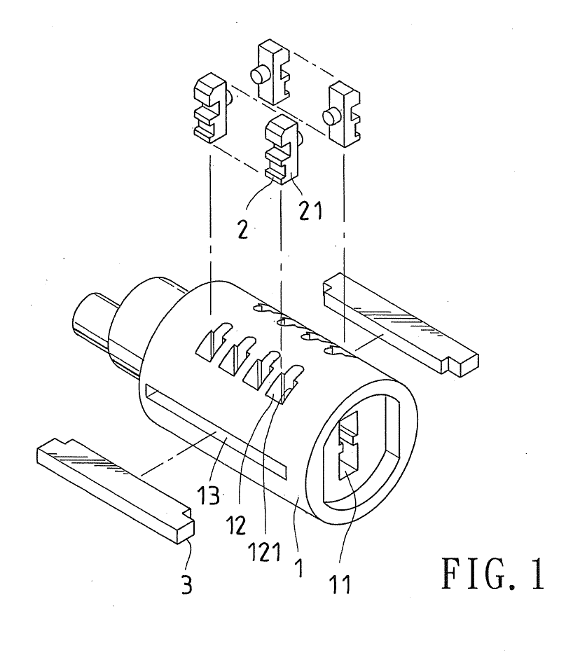

Referring to FIG. 1, a perspective exploded view according to the present invention is revealed. The lock core structure comprises a lock core (1), a plurality of locking pieces (2), and locking strips (3). The lock core (1) has a keyhole (11) for inserting and rotating a key therein and has a plurality of engaging holes (12) arranged at least one row thereon for accommodating the locking pieces (2). Each of the engaging holes (12) communicating with the keyhole (11) is defined by a curved portion and a flat portion, wherein the flat portion includes at least one first flat surface (121). Each of the locking pieces (2) for insertion into the engaging hole (12) has an E-shaped configuration and includes at least one second flat surface (21) on laterals thereof to prop against the at least one first flat surface (121) of the flat portion of each of the engaging holes (12). The lock core (1) is further provided with a plurality of slots (13) for insertion of the locking strips (3) to prop against the locking pieces (2).

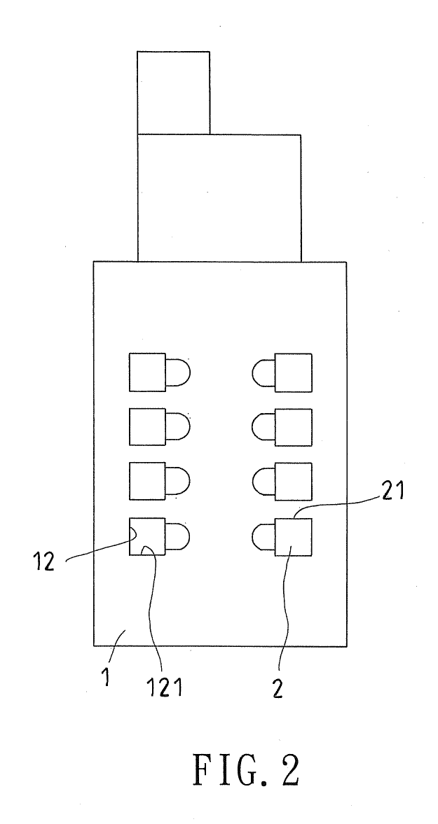

Referring to FIG. 2, a schematic diagram showing the assembly of a lock core structure according to the present invention is disclosed. Plural locking pieces (2) are respectively inserted into the engaging holes (12) of a lock core (1), and the second flat surfaces (21) of the locking to pieces (2) prop against the first flat surfaces (121) of the engaging holes (12) for limiting and fixing each other in position. Each of plural slots (13) of the lock core (1) respectively accommodates a locking strip (3) therein allowing the locking strips (3) to prop against the locking pieces (2). In general state, the locking strips (3) protrude from the slots (13) on outer case of the lock core (1) so that the lock core (1) is in a closed state. On the other hand, in the presence of a key in the keyhole (11), teeth on the key corresponding to the locking pieces (2) inside the engaging holes (12) can drive the locking pieces (2) to move so that the locking pieces (2) are pressed into the slot (13). In such a case, rotating the key can also actuate the rotation of the lock core (1) for unlocking.

According to the present invention, each of the engaging holes (12) and the locking pieces (2) are respectively provided with four first flat surfaces (121) and four second flat surfaces (21) for propping against each other in position, which causes each engaging hole (12) and each locking piece (2) form a rectangular shape.

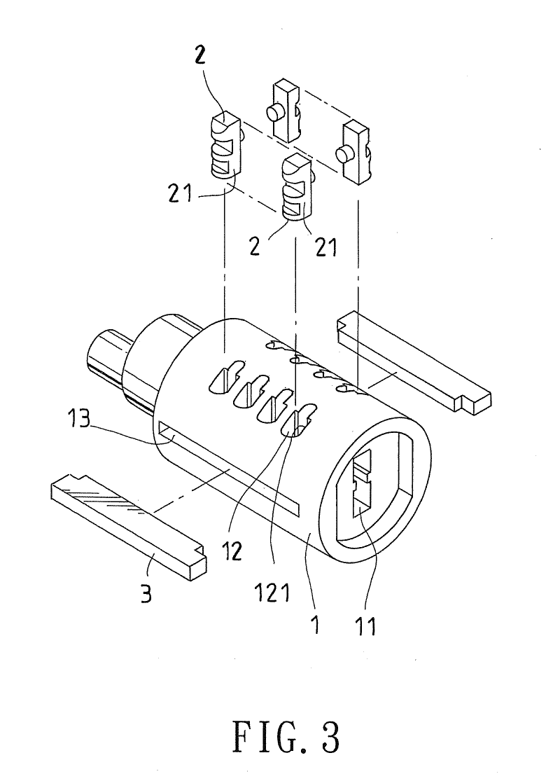

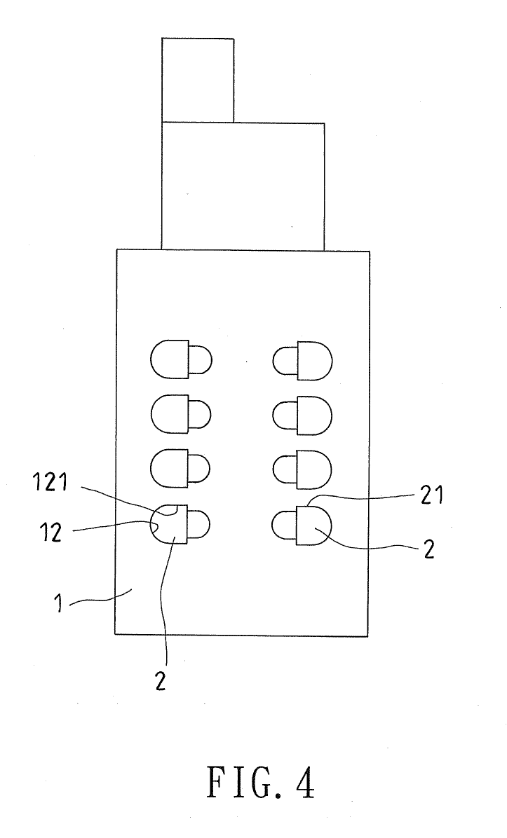

Referring to FIG. 3 and FIG. 4, another perspective exploded view according to the present invention and another schematic diagram showing a lock core structure in assembly are revealed. Each of the engaging holes (12) and the locking pieces (2) can be disposed with only one or two first flat surfaces (121) and one or two second flat surfaces (21), respectively, for limiting and fixing each other in position.

According to the above description, in comparison with the traditional technique, a lock core structure according to the present invention has first flat surfaces and second flat surfaces respectively on laterals of each engaging hole and each locking piece for limiting each other in position. Therefore, the lock core structure can prevent the locking pieces from casual movement and shift in the engaging holes and allow a key to be smoothly inserted into a keyhole of a lock core so as further to increase the expediency in use thereof.

1. A lock core structure, comprising:
a lock core having an inner core section disposed within an outer case formed with a keyhole for insertion and rotation of a key, the lock core having a plurality of engaging holes arranged along at least one row thereon, each of the engaging holes communicating with the keyhole and being defined by a curved portion and a flat portion including at least one first flat surface, the outer case having at least one slot formed therein;
a plurality of locking pieces, each having a substantially E-shaped configuration for displaceable insertion into the engaging holes along a first direction, and including at least one second flat surface on laterals thereof to prop against the at least one first flat surface of the flat portion of each of the engaging holes; and
a locking strip displaceably received in the slot of the lock core to engage the inner core section for releasably locking the inner core relative to the outer case, the locking strip being displaceable in a second direction transversely offset from the first direction;
wherein each of the locking pieces is displaceable in the first direction responsive to insertion of the key in the keyhole to drive disengagement of the locking strip from the inner core section.

2. The lock core structure as claimed in claim 1, wherein the engaging hole and the locking piece form a rectangular shape.
